(19) United States
(12) Patent Application Publication
(10) Pub. No.: US 2002/0090955 A1
(43) Pub. Date: Jul. 11, 2002

(54) Tracking system using an existing wireless network

(76) Inventors: Robert Nelson, Hampstead (CA); Andre Eric Boulay, Kirkland (CA)

Correspondence Address: MERCHANT & GOULD PC, P.O. BOX 2903, MINNEAPOLIS, MN, 55402-0903, US

(21) Appl. No.: 09/957,177

(22) Filed: Sep. 19, 2001

(30) Foreign Application Priority Data
Sep. 19, 2000 (CA) 2,320,519

(51) Int. Cl. H04Q 7/20

(52) U.S. Cl. 455/456; 701/213; 342/357.1; 340/991

(57) ABSTRACT

A system for tracking an object being provided with a tracking wireless transceiver and a positioning system in communication with the tracking wireless transceiver is disclosed. The system includes a receiver for receiving an indication that the object needs to be tracked; a pager for paging the tracking wireless transceiver; and a trigger for activating the positioning system, so that the positioning system obtains preliminary positioning information from the positioning system and relays the preliminary positioning information to the tracking wireless transceiver. The tracking wireless transceiver sends the preliminary positioning information to a central location. The system also includes a beacon for emitting a signal, which is activated when the tracking wireless transceiver has been paged. The system further includes a radio location finder for tracking the object based on the preliminary positioning information and a direction of travel of signals emitted by the beacon and received at a search vehicle.

### FIELD OF THE INVENTION

The present invention relates to a tracking system and method using an existing wireless network, to locate vehicles or other objects. Description of the prior art The present invention is an improvement over U.S. Pat. No. 5,895,436 to Savoie et al. That patent discloses a vehicle tracking method and system using the cellular network infrastructure. A cellular transceiver is installed in a vehicle which requires tracking, and operates on a continuously stand-by mode, to remain accessible to the cellular security provider. The cellular transceiver is turned on to an active mode when tracking of the vehicle is initiated. The general location of the stolen vehicle can be determined by paging the cellular transceiver located in the stolen vehicle to identify one or more cell sites located near the stolen vehicle. The information is then relayed to a tracking vehicle which makes use of a radio direction finder to obtain an accurate bearing on the location of the stolen vehicle. In another embodiment, the tracking vehicle which is provided with a radio direction finder can determine using a global positioning system receiver its location with respect to one or more cell sites identified as being close to the stolen vehicle such that the tracking vehicle can quickly travel to the area identified by the selected cell sites.

One of the main issues of that patent is conserving the integrity and security of the on-board system. In fact, the on-board system must be hidden from view, so as to prevent a potential thief from disarming the system.

However, a problem with using such a system is that the cellular provider must, in order for the vehicle to be tracked, provide information relating to location of cell sites, and must also give access to other proprietary information. Some cellular providers do not wish such information to be revealed. Furthermore, the system there described requires that an open channel be maintained to obtain preliminary location information, which can be costly.

### SUMMARY OF THE INVENTION

One of the objects of the present invention is to provide a tracking system similar to the one disclosed in U.S. Pat. No. 5,895,436, using an existing wireless network to locate a variety of objects, but which minimises the use of the cellular network, and is thus more economical to operate. In accordance with the invention, this object is achieved with a system for tracking an object being provided with a tracking wireless transceiver and a positioning system in communication with the tracking wireless transceiver, comprising:

a receiver for receiving an indication that the object needs to be tracked;

means for paging the tracking wireless transceiver;

means for activating the positioning system, so that the positioning system obtains preliminary positioning information and relays said positioning information to said tracking wireless transceiver, and said tracking wireless transceiver sending said positioning information to a central location;

a beacon, said beacon being activated when said tracking wireless transceiver has been paged, said beacon emitting a signal;

radio location finder means for tracking the object based on the preliminary positioning information and a direction of travel of signals emitted by the beacon and received at a search vehicle.

In a preferred embodiment of the invention, the positioning system is a GPS system. Such systems are commercially available. The GPS system can be wired to the tracking wireless transceiver, which has the disadvantage of somewhat compromising the stealthness of the location equipment on board the vehicle, although there are more recent GPS systems which can be partially hidden from view. Alternatively, the GPS can be in wireless communication with the tracking wireless transceiver on board the vehicle.

Furthermore, since only the positioning information is sent to the central location, the use of a cellular network is minimised, and does not require the cellular operator to divulge proprietary information. Accordingly, the tracking wireless transceiver is further preferably provided with a form of beacon which is activated when the positioning information is relayed to the central location. Consequently, when the object needs to be tracked, the search vehicle obtains preliminary location information from the positioning system, i.e. the GPS system. Afterwards, the search vehicle relies on the beacon emitted by the tracking wireless transceiver to obtain more precise location information.

### BRIEF DESCRIPTION OF THE DRAWINGS

The present invention and its advantages will be more easily understood after reading the following non-restrictive description of preferred embodiments thereof, made with reference to the following drawings in which:

FIG. 1 is a block diagram of the locating cellular transceiver of the present invention;

FIG. 2 is an illustration of the vehicle tracking system of the present invention;

FIG. 3a is a block diagram of the vehicle tracking equipment provided on a search vehicle; and

FIG. 3b is a diagram illustrating the location or direction finding GPS and transceiver antennae used with the system of FIG. 3a.

### DESCRIPTION OF A PREFERRED EMBODIMENT OF THE INVENTION

As mentioned previously, the present invention concerns a tracking system and method which is an improvement over the prior art, and more particularly, over U.S. Pat. No. 5,895,436.

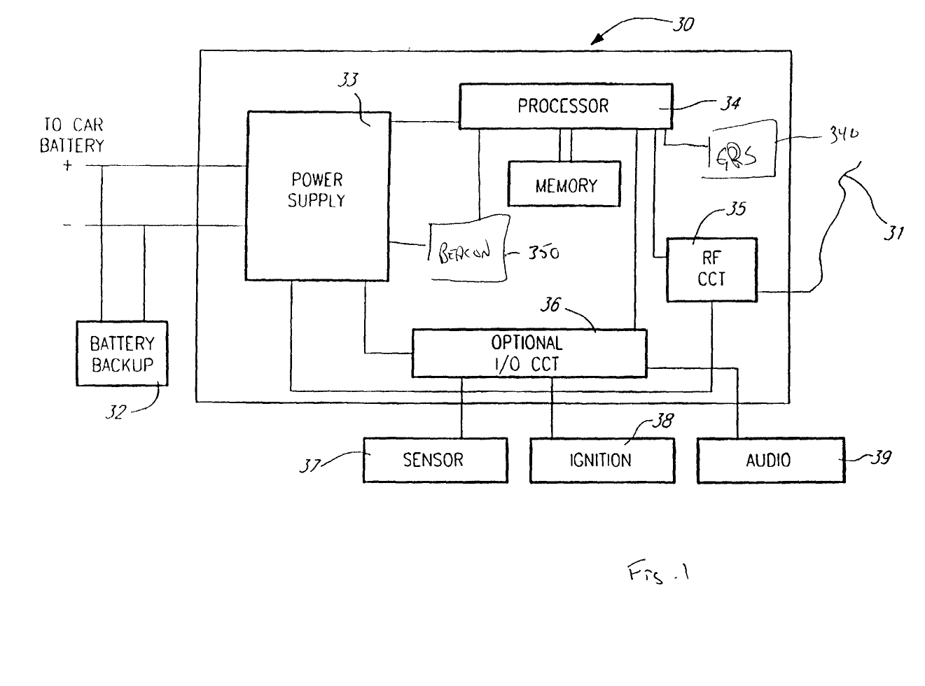

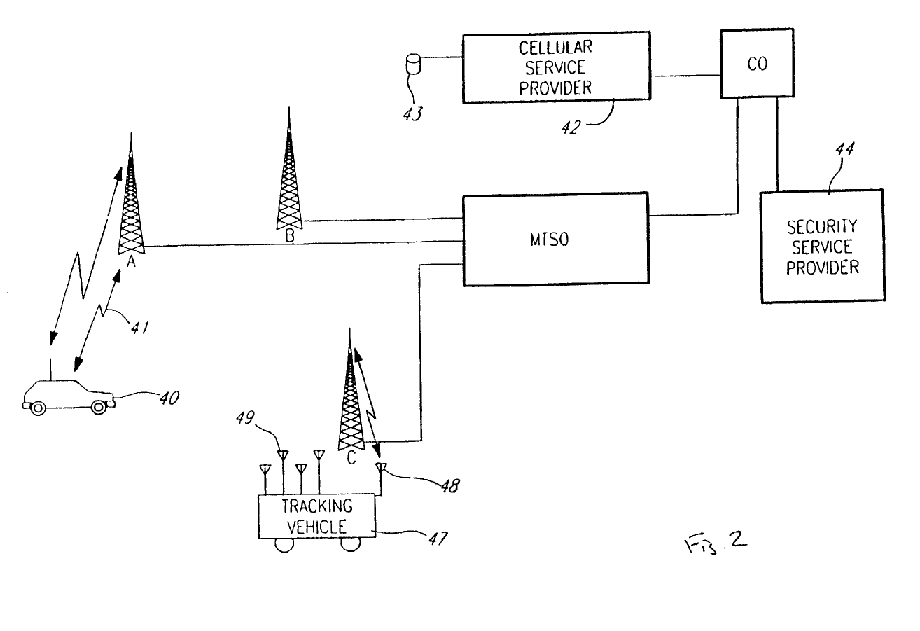

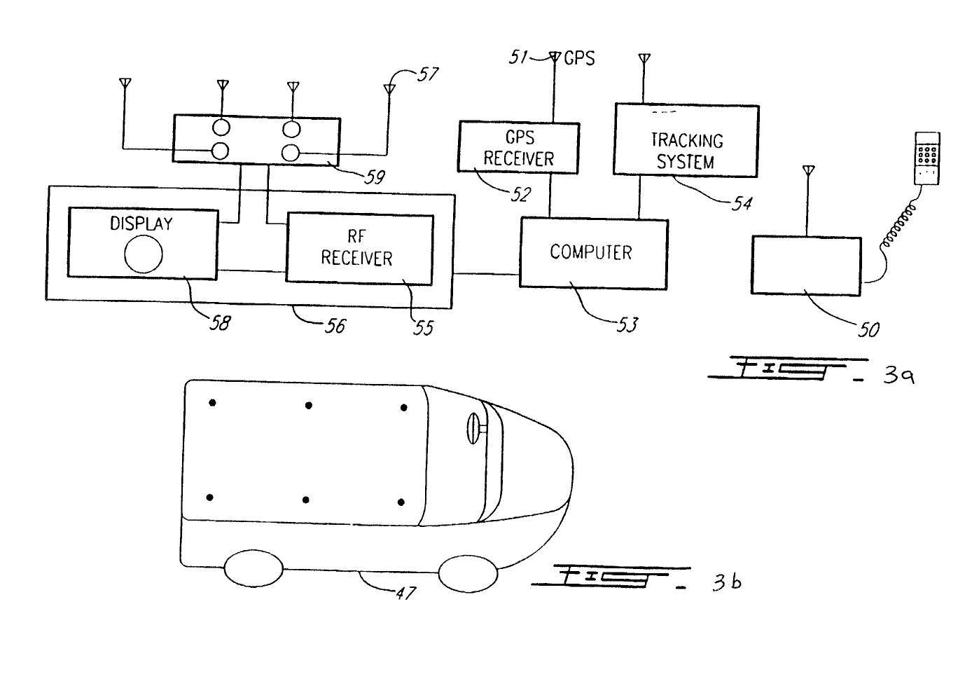

In present tacking systems, a tracking wireless transceiver 30 is placed on board the vehicle or object. Power means are provided by a battery, such as car battery in FIG. 1, and battery backup means 32 are also preferably provided. Transceiver 30 is provided with a power supply 33, a processor 34, RF circuitry 35 and an optional input/output circuit 36, which may be connected to sensors 37, ignition 38 (in the case of a vehicle), and have an audio output 39. In the context of the present invention, transceiver 30 is further provided with a positioning system 340, in this case preferably a GPS module, which is adapted to receive positioning information from a constellation of satellites. Other independent positioning systems can also be used for the purposes of the present invention.

When an object or vehicle 40 needs to be tracked, means are provided for receiving an indication that the object needs to be tracked, such as an owner reporting to a security service provider 44 theft of a vehicle.

The tracking wireless transceiver 30 on board vehicle 40 is paged, preferably through a data communication channel of a cellular network, although other means are contemplated by the present invention.

When transceiver 30 is paged, processor 34 activates the positioning system 340, so that the positioning system obtains positioning information from a plurality of satellites and relays this positioning information to the tracking wireless transceiver 30.

Through the same channel, or another channel, the tracking wireless transceiver 30 sends the positioning information to a central location 44. The transceiver also activates a beacon 350. The beacon is preferably an RF emitter, which emits, sporadically, regularly or continuously, a signal.

The central location 44 sends the initial tracking information to a tracking vehicle 48, which is provided with radio location finder means for tracking the object based on the preliminary positioning information and a direction of travel of RF signals emitted by the wireless transceiver and received at a search vehicle.

Consequently, when the object needs to be tracked, the search vehicle obtains preliminary location information from the positioning system, i.e. the GPS system. Afterwards, the search vehicle relies on the beacon emitted by the tracking wireless transceiver to obtain more precise location information and eventually located the object that needs to be tracked.

As mentioned previously, in a preferred embodiment of the invention, the positioning system is a GPS system. Such systems are commercially available. The GPS system can be wired to the tracking wireless transceiver, which has the disadvantage of somewhat compromising the stealthness of the location equipment on board the vehicle, although there are more recent GPS systems which can be partially hidden from view. Alternatively, the GPS can be in wireless communication with the tracking wireless transceiver on board the vehicle.

For the purposes of the present invention, since in any event a tracking vehicle will be used to track the object using a beacon activated by the transceiver 30, the accuracy of the positioning system does not need to be high, and can be, for example, within 500 meters.

Furthermore, since only the positioning information is sent to the central location, the use of a cellular network is minimised, and does not require the cellular operator to divulge proprietary information.

It should be understood that in the context of the present invention, an object that need to be tracked includes vehicles, machinery, ships, or anything or anybody else which can be equipped with a transceiver 30.

1. A system for tracking an object being provided with a tracking wireless transceiver and a positioning system in communication with the tracking wireless transceiver, comprising:
a receiver for receiving an indication that the object needs to be tracked;
means for paging the tracking wireless transceiver;
means for activating the positioning system, so that the positioning system obtains preliminary positioning information and relays said preliminary positioning information to said tracking wireless transceiver, and said tracking wireless transceiver sending said positioning information to a central location;
a beacon located on the object, said beacon being activated when said tracking wireless transceiver has been paged, said beacon emitting a signal; and
radio location finder means for tracking the object based on the preliminary positioning information and a direction of travel of signals emitted by the beacon and received at a search vehicle.

2. A system according to claim 1, wherein said positioning system is a GPS system.

3. A system according to claim 2, wherein said GPS system is in wireless communication with said tracking wireless transceiver.

4. A system according to claim 1, wherein said beacon emits sporadically, regularly, or continuously.

5. A system according to claim 1, wherein said beacon emits a RF signal.
